(19) United States
(12) Patent Application Publication
(10) Pub. No.: US 2014/0326109 A1
(43) Pub. Date: Nov. 6, 2014

(54) ADJUSTABLE WRENCH

(71) Applicants: Yuexiao Ma, Shandong (CN); Jianwei Ma, Shandong (CN)

(72) Inventors: Yuexiao Ma, Shandong (CN); Jianwei Ma, Shandong (CN)

(21) Appl. No.: 14/358,227

(22) PCT Filed: Aug. 15, 2012
(86) PCT No.: PCT/CN2012/080169

§ 371 Date: May 15, 2014

(30) Foreign Application Priority Data
Nov. 18, 2011 (CN) 20111035776.X

(51) Int. Cl. B25B 13/16; B25B 13/20

(52) U.S. Cl. CPC B25B 13/16; B25B 13/20
USPC 81/166; 81/129

(57) ABSTRACT

An adjustable wrench comprises a handle. At least one end of the handle is provided with a straight claw (2) and an oblique claw (1), which form a wrench jaw by a certain angle. The straight claw is provided with an adjusting slider (4) capable of moving along the length direction of the straight claw and the adjusting slider comprises an oblique face (41) in action with a nut, and the oblique face is parallel to the inner surface (11) of the oblique claw forming the wrench jaw. The adjustable wrench retains advantages of a solid wrench which is precise in the opening size and not easy to slip, and solves the problem that the opening width of the existing solid wrench cannot be adjusted. Meanwhile, the adjustable wrench completely retains the advantage of the existing adjustable wrench which is continuously adjustable in the opening width, and solves the problems that since a shifting wheel and a rack are easy to abrade, slipping is easy to occur or nuts can be damaged.

### BACKGROUND OF THE INVENTION

The present invention relates to a new type wrench, specifically to a new type adjustable wrench.

The wrench is a kind of commonly used tool. There are many kinds of wrenches, which can be divided into two kinds according to the adjustability: adjustable wrench and solid wrench. The two different kinds of wrenches are of different advantages and disadvantages.

1. The advantages and disadvantages of the existing solid wrench

The existing solid wrenches adopt generally double-end design. Namely, one solid wrench can be used to screw or unscrew hexagon nut of two sizes. Therefore, it is troublesome but necessary to prepare multiple wrenches. In order to improve the existing wrenches, a lot of improvements have been done. The Chinese patent CN89107375 discloses an adjustable multipurpose wrench, as shown in FIG. 1, 5 is a lower holding claw in shape of thumb connected with a handle, and 1 is a bended upper holding claw, on which a strip-shaped hole 3 with multiple articulating positions is provided; 5 and 1 are connected together through a pivot 4 to form a holding wrench jaw; size of the wrench jaw can be adjusted by adjusting articulating position of the upper holding claw 1 and the pivot 4 or by rotating angle of the claw 1 with pivot 4 as fulcrum. It can be used to screw or unscrew bolt, nut and pipe joint, or same kind of connecting pieces within a predefined size range; besides, it is also suitable for different nuts or pipe diameters. However, when it is used to screw or unscrew hexagon nut, it is easy to damage corner of the nut because point A is generally point contact.

2. The advantages and disadvantages of the existing adjustable wrench

The existing adjustable wrench is popular because it is suitable for many nuts of different sizes and width of the wrench jaw can be continuously adjusted. But it has very obvious disadvantages. Firstly, the slipping problem is easy to occur. Everyone who ever uses the wrench knows that slipping problem is easy to occur or it is easy to damage corner of nut in case of improper adjustment. Since the opening adjusting direction is the same as the stress direction, even if the opening width is the same as size of the nut, the wrench opening will become bigger in use because there is gap between the adjusting wheel and the rack, which results in slipping problem or damage to the nut. Secondly, because the adjusting mechanism is provided, the production cost is increased and it is more difficult to manufacture. The working efficiency is low, although the adjustable wrench can be used to screw and unscrew hexagon nut of different sizes, it is necessary to adjust opening width of the wrench, so it is inconvenient but necessary to adjust the opening width for many times to make it the same as size of nuts. If the opening width is not adjusted properly, it is easy to damage corners of nuts. The Chinese patent CN92100748.5 discloses a multipurpose solid wrench, as shown in FIG. 2, which is improvement of the previous solid wrench, being convenient, practical and efficient. However, it is suitable for nuts of only six different sizes, and also easy to damage corners of nuts. The Chinese utility model ZL92105567 discloses a wedge type wrench, as shown in FIG. 3, sliding holes are respectively provided on the working faces of the two claws of solid wrench, with one wedge placed in the two sliding holes respectively. The this wrench is used to screw the nut, the two wedges can be tightly matched with the nut, when it is necessary to change holding position after screwing for one time, it is only necessary to turns the wrench reversely but unnecessary to take it out and then insert it. While turning the wrench reversely, the wedges press spring so the wrench jaw becomes bigger, thus to improve working efficiency. Because distance between the two claws is fixed, it is still necessary to prepare multiple wrenches during working, which limits application scope of the wrench. Besides, the wrench has multiple components, so the structure is complex, which influences the stability. The Chinese utility model ZL02270676.3 discloses a single-wedge type wrench, as shown in FIG. 4, comprising a wedge 3 and a claw 1, wherein the wedge 3 comprises saw-toothed slot, and the wedge 3 is connected with one claw 4 and capable of sliding along inner side of the claw 4; and the angle formed by the inner side and the holding face of claw is greater than 0° and less than 90°; and a spring 5 is provided longitudinally between the wedge and claw. When this wrench is used to screw nuts, it is unnecessary to take the wrench out and reinsert it, it is only necessary to turn the wrench reversely. While turning the wrench reversely, the wedges press spring so the wrench jaw becomes bigger, thus to improve working efficiency. Because there are multiple tooth-shaped parts on the working face of the wedge, which improves friction force and holding force and can efficiently “bite” the objects, namely tightly clamp nuts and round pipes to function as pipe wrench. But it still has disadvantage of slipping problem and damage to the nuts.

To sum up, although there are many improvement designs of wrench, the problems that adjustable wrench is easy to slip and the solid wrench cannot be adjusted are still not solved completely. Because the opening adjusting direction of the adjustable wrench is the same as the stress direction, and there is gap between the shifting wheel and the rack, when it is used to screw nuts, opening of the wrench becomes bigger, thus slipping problem is easy to occur or nuts can be damaged. And improvements of the solid wrench mainly focus on reducing reinsertion operation of wrench, but do not solve the adjustability problem.

### BRIEF SUMMARY OF THE INVENTION

Aiming at the disadvantages of the existing technology, the technical problem to be solved in the present invention is to provide an adjustable wrench, which can solve the problems that the opening width of the existing solid wrench cannot be adjusted, and the shifting wheel and the rack are easy to be abraded because the opening adjusting direction of the existing adjustable wrench is the same as the stress direction, as well as problem that slipping problem is easy to occur or nuts can be damaged because engagement gap between the shifting wheel and the rack becomes bigger.

In order to solve the above problems, the technical proposal of the present invention is as follows: An adjustable wrench which comprises a handle, wherein at least one end of the handle is provided with a straight claw and an oblique claw, which form a wrench jaw by a certain angle; the straight claw is provided with an adjusting slider capable of moving along the length direction of the straight claw, and the adjusting slider comprises an oblique face in action with a nut, and the oblique face is in parallel with the inner surface of the oblique claw which forms the wrench jaw.

Further, a locating mechanism which can be fixed at any position on the straight claw is provided between the adjusting slider and the straight claw.

Further, the locating mechanism is a set screw provided on the lateral side or bottom of the adjusting slider.

Further, the locating mechanism includes locking saw teeth that are matched with each other and provided on the sliding action face of the straight claw and the adjusting slider.

Further, a bolt is provided on the adjusting slider in the way of passing through the inner part of the adjusting slider, and a rotatable shifting wheel that is matched with the bolt is fixed on the straight claw, and the shifting wheel is rotated to drive reciprocating motion of the adjusting slider along the straight claw.

Further, the opening angle formed between the straight claw and the oblique claw is 5°-40°.

Advantages of the adjustable wrench of the present invention are as follows: by arrangement of the straight claw and the oblique claw in a certain angle, the nut action face of the adjusting slider is always in parallel with the inner surface of the oblique claw during the movement process. In use, the stress to the nut is vertical to the inclined surface of the adjusting slider, so the component force of the action force along the movement direction of adjusting slider is small, and the slipping problem is not easy to occur; besides, it has locking function and retains advantages of the solid wrench which is precise in the opening size and not easy to slip, and solves the problem that the opening width of the existing solid wrench cannot be adjusted, so it is unnecessary to prepare multiple wrenches during working. Meanwhile, the adjustable wrench of the present invention completely retains the advantage of the existing adjustable wrench which is continuously adjustable in the opening width, and solves the problems that a shifting wheel and a rack are easy to be abraded because the opening adjusting direction is the same as the stress direction, which results in that engagement gap between the shifting wheel and the rack becomes bigger, thus slipping problem is easy to occur or nuts can be damaged in case of improper adjustment.

### BRIEF DESCRIPTION OF THE DRAWINGS

FIG. 1 is the structural diagram of the common adjustable multipurpose wrench of the existing technology;

FIG. 2 is the structural diagram of the common multipurpose solid wrench;

FIG. 3 is the structural diagram of the double-wedge type wrench;

FIG. 4 is the structural diagram of the single-wedge type wrench;

FIG. 5 is the structural diagram of the present invention;

FIG. 6 is the structural diagram of embodiment 1 of the present invention;

FIG. 7 is the structural diagram of embodiment 2;

FIG. 8 is the structural diagram of embodiment 3;

FIG. 9 is the structural diagram of embodiment 4;

FIG. 10 is the local section diagram of matched tenon and slot of straight claw in embodiment 4 of the present invention;

FIG. 11 is the structural diagram of embodiment 5;

FIG. 12 is the A-directional diagram of embodiment 5;

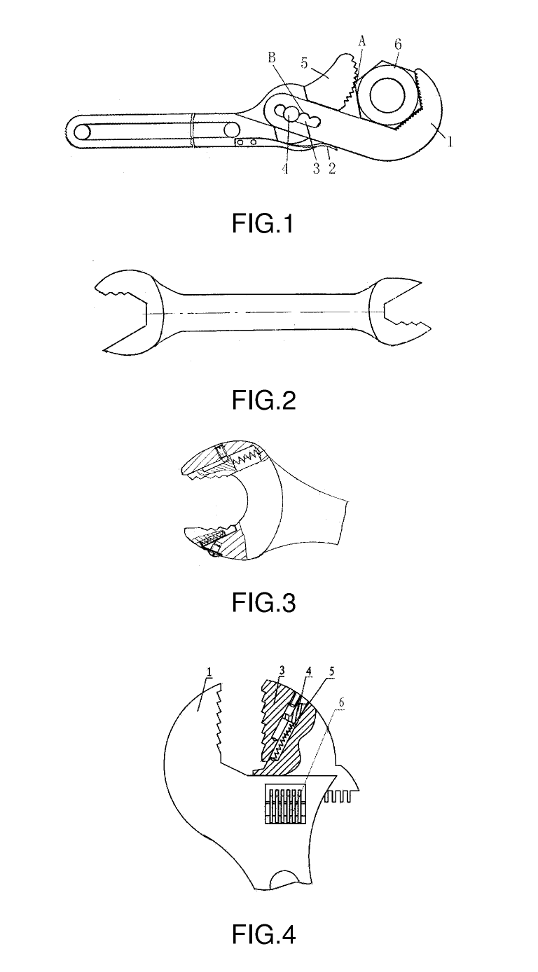

### DETAILED DESCRIPTION OF THE INVENTION

The following is detailed description of the present invention in combination with the drawings and embodiments.

### Embodiment 1

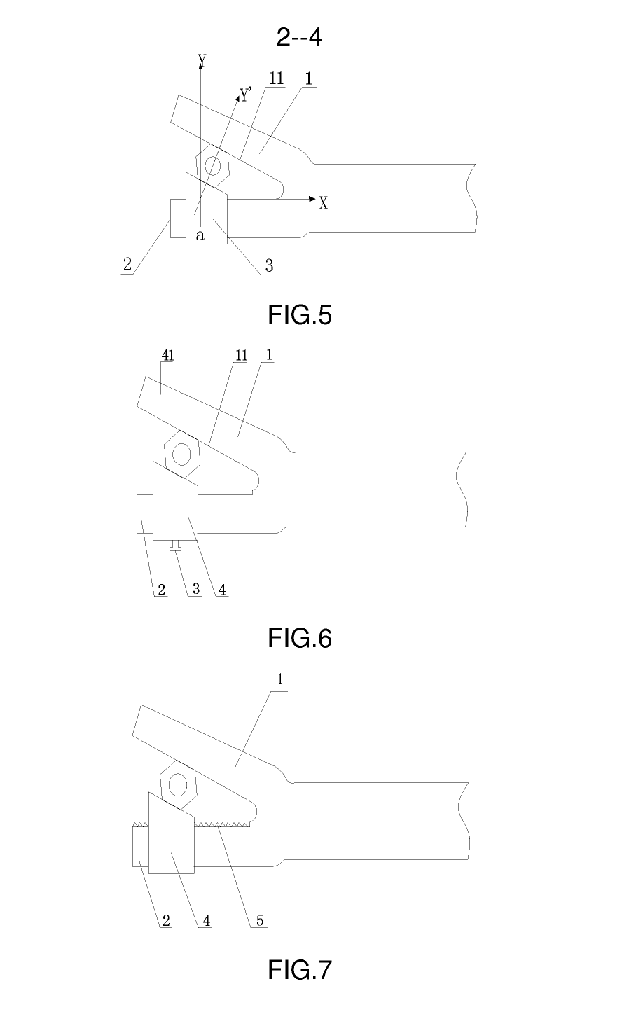

As shown in FIG. 5 and FIG. 6, an adjustable wrench which comprises a handle, wherein at least one end of the handle is provided with a straight claw 2 and an oblique claw 1, which form a wrench jaw by a certain angle; the straight claw 2 is provided with an adjusting slider 4 capable of moving along the length direction of the straight claw, and the adjusting slider 4 comprises an oblique face 41 in action with a nut, and the oblique face 41 is in parallel with the inner surface 11 of the oblique claw 1 which forms the wrench jaw. The wrench comprises the oblique claw 1, the straight claw 2 and the adjusting slider 4, wherein the adjusting slider 4 is provided with an oblique face 41, the oblique angle is α, and the angle of wrench jaw formed between the straight claw 2 and the oblique claw 1 is 5°-40°, preferably 15° in the present invention, so as to reduce rotation amplitude of the wrench handle and protect nuts from being damaged. Except the existence of the adjusting slider 4, it is almost the same as the solid wrench, while the only difference is the camber angle α of the oblique claw 1, so the oblique claw 1 and the oblique face 41 of the adjusting slider 4 form a holding wrench jaw. As a result, width of the wrench jaw formed by the adjusting slider 4 and the oblique claw 1 in the Y′ direction can be adjusted by adjusting position of the slider 3 in the X direction, thus to adapt nuts of different sizes. In this way, while screwing nuts, the force to the adjusting slider 4 is mainly pressed to the straight claw 2, so the force stressed to the oblique face 41 is in the vertical direction, while the component force from pushing the adjusting slider 4 to move from side to side is small. A locating mechanism that can be fixed at any position on the straight claw 2 is provided between the adjusting slider 4 and the straight claw 2. The locating mechanism is a set screw provided at the lateral side or bottom of the adjusting slider 4, so as to fix the adjusting slider 4 tightly on the straight claw 2 to prevent the slipping problem.

### Embodiment 2

In this embodiment, the same part with the embodiment 1 is omitted, and the difference is as follows: as shown in FIG. 7, the locating mechanism is the matched locking saw-teeth 5 provided on the sliding face of the straight claw 2 and the adjusting slider 4.

### Embodiment 3

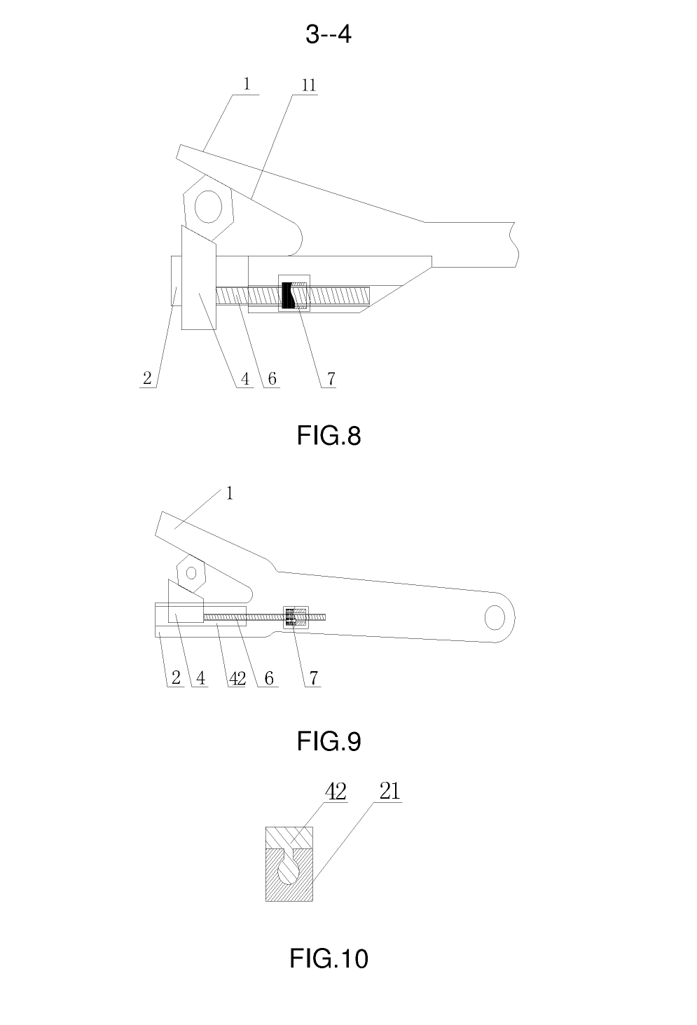

In this embodiment, the same part with the embodiments 1 and 2 is omitted, and the difference is as follows: as shown in FIG. 8, the adjusting slider 4 is actively sleeved on the straight claw 2 and fixed with the bolt 6, and the adjusting slider 4 is driven by the bolt 6 through rotating the shifting wheel 7 to carry out reciprocating motion, so as to adjust opening width to adapt nuts of different sizes; meanwhile, the interaction between the shifting wheel 7 and the bolt 6 also functions as locking the adjusting slider 4.

### Embodiment 4

In this embodiment, the same part with the embodiments 1, 2 and 3 is omitted, and the difference is as follows: as shown in FIG. 9 and FIG. 10, the adjusting slider 4 is in insertion match with the slot 21 of the straight claw 2 through its tenon 42; because the bolt 6 is welded together with the adjusting slider 4, the adjusting slider 4 is driven to move from side to side through rotating the shifting wheel 7, thus to adjust the opening width.

### Embodiment 5

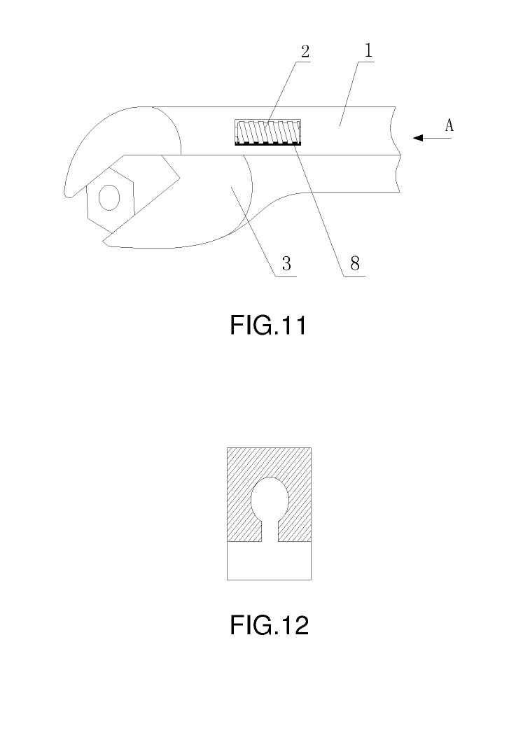

In this embodiment, the same part with the embodiments 1, 2, 3 and 4 is omitted, and the difference is as follows: as shown in FIG. 11 and FIG. 12, the wrench of the present invention can also adopt the following structure: the wrench comprises an oblique claw with a square hole, an oblique claw 3 with rack 4, and a bolt-shaped shifting wheel 2, as shown in FIG. 10. Therefore, the adjusting slider 3 can be driven to move from side to side by rotating the shifting wheel 2, thus to adjust the opening width.

The above description is not limitation of the present invention, and the present invention is not limited to the above embodiments. Any change, modification, addition or replacement within the essential scope of the present invention by technicians of this technical field shall belong to protective scope of the present invention.

1. An adjustable wrench which comprises a handle, wherein at least one end of the handle is provided with a straight claw and an oblique claw, which form a wrench jaw by a certain angle; the straight claw is provided with an adjusting slider capable of moving along the length direction of the straight claw, and the adjusting slider comprises an oblique face in action with a nut, and the oblique face is in parallel with the inner surface of the oblique claw which forms the wrench jaw.

2. The adjustable wrench according to claim 1, wherein a locating mechanism which can be fixed at any position on the straight claw is provided between the adjusting slider and the straight claw.

3. The adjustable wrench according to claim 2, wherein the locating mechanism is a set screw provided on the lateral side or bottom of the adjusting slider.

4. The adjustable wrench according to claim 2, wherein the locating mechanism includes locking saw teeth that are matched with each other and provided on the sliding action face of the straight claw and the adjusting slider.

5. The adjustable wrench according to claim 2, wherein a bolt is provided on the adjusting slider in the way of passing through the inner part of the adjusting slider, and a rotatable shifting wheel that is matched with the bolt is fixed on the straight claw, and the shifting wheel is rotated to drive reciprocating motion of the adjusting slider along the straight claw.

6. The adjustable wrench according to claim 5, wherein the opening angle formed between the straight claw and the oblique claw is 5°-40°.

7. The adjustable wrench according to claim 3, wherein a bolt is provided on the adjusting slider in the way of passing through the inner part of the adjusting slider, and a rotatable shifting wheel that is matched with the bolt is fixed on the straight claw, and the shifting wheel is rotated to drive reciprocating motion of the adjusting slider along the straight claw.

8. The adjustable wrench according to claim 4, wherein a bolt is provided on the adjusting slider in the way of passing through the inner part of the adjusting slider, and a rotatable shifting wheel that is matched with the bolt is fixed on the straight claw, and the shifting wheel is rotated to drive reciprocating motion of the adjusting slider along the straight claw.
